(19) United States
(12) Patent Application Publication
(10) Pub. No.: US 2022/0019972 A1
(43) Pub. Date: Jan. 20, 2022

(54) DYNAMICALLY ROUTABLE UNIVERSAL REQUEST

(71) Applicant: ServiceNow, Inc., Santa Clara, CA (US)

(72) Inventors: Harshvardhan Prasad, Hyderabad (IN); Aditya Mallik Manthripragada, Hyderabad (IN); Bhavneet Kaur, Bengaluru (IN); Ramon Colcer, San Jose, CA (US); John Botica, Escondido, CA (US); Simran Sawhney, Hyderabad (IN); Shouvik Goswami, Hyderabad (US); Apeksha Deval, Hyderabad (IN); Kenneth James Hamer, Ramona, CA (US); Rao Surapaneni, San Jose, CA (US); Allan Sabol, Poway, CA (US); Christy Rounds, La Mesa, CA (US)

(21) Appl. No.: 16/933,804

(22) Filed: Jul. 20, 2020

(51) Int. Cl. G06Q 10/10; H04L 29/08; G06Q 10/00; G06Q 30/00; G06Q 10/06; G06N 20/00

(52) U.S. Cl. CPC G06Q 10/103; H04L 67/32; G06Q 10/20; G06Q 10/105; G06N 20/00; G06Q 10/107; G06Q 10/0639; G06Q 10/063114; G06Q 30/016

(57) ABSTRACT

A service request is received. A universal service request ticket is created for the service request. The service request is routed to a dynamically selected service domain including by creating for the dynamically selected service domain a child service request ticket of the universal service request ticket. A status of the universal service request ticket is updated based on a status of the child service request ticket of the dynamically selected service domain.

### BACKGROUND OF THE INVENTION

Computer systems can be used to track, manage, and provide services to users. For example, a user is able to request a service by creating a service request ticket that gets tracked, managed, and resolved using networked computer systems. An organization often provides computer network-based support services for its users in various different and independent service domains. For example, information technology (IT) services, employee/human resources services, and customer services reside in different service domain silos that are managed and processed independently given their specialized distinct functionality. When a user requests a service, the user must often select the specific service domain of the user's request. If the user creates a ticket in one service domain that turns out to be the incorrect domain to handle the user's request, often the user must close this ticket and open a new ticket in the different correct domain. As the user base grows, computerized service networks (e.g., incident tracking systems) may receive larger volumes of request data (e.g., ticket data). Creation and deletion of a large number of tickets may result in extra processing that burdens the service network, introduces technical complexities for the user, makes complete computer system user experience difficult to track, extends average resolution time for requests, consumes storage resources of the service network, or a combination thereof.

### BRIEF DESCRIPTION OF THE DRAWINGS

Various embodiments of the invention are disclosed in the following detailed description and the accompanying drawings.

FIG. 1 is a schematic diagram of an embodiment of a computing system.

FIG. 2 is a flowchart illustrating an embodiment of a process for managing and handling a universal service request ticket.

FIG. 3 is a flowchart illustrating an embodiment of a process for processing a universal service request ticket.

FIGS. 4A-4G show example user interfaces associated with a universal service request ticket.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A universal service request ticket (i.e., universal ticket) is disclosed. The universal ticket allows the same service request ticket to be forwarded to different service domains under the same cohesive universal ticket. For example, a user that does not know which department the user's request belongs to can submit a universal service request ticket that can be triaged and forwarded to one or more appropriate departments under the same universal ticket with end-to-end management and accountability maintained under the same universal ticket. This improves user experience as well as computer performance and end-to-end computer processing tracking and analysis.

In some embodiments, a service request is received (e.g., without a specification of a specific service domain to handle the service request). For example, a user indicates via a submission of an electronic form or conversation with a chatbot or other agent, a desired service or problem to be resolved without specifying which specific service domain (e.g., department) the request belongs to. A universal service request ticket is created and the service request is routed to a dynamically selected service domain. For example, the dynamically selected service domain is automatically determined using machine learning or by a triage/routing universal ticket agent. A child service request ticket (i.e., child ticket) is automatically created in the dynamically selected service domain. The child service request ticket is linked to the universal ticket and can be tracked and managed under the universal ticket. A status of the universal ticket is updated based on a status of the child ticket. For example, the selected service domain is able to process the child ticket as normal but the management and interaction associated with the child ticket by the requestor user is provided via the universal ticket.

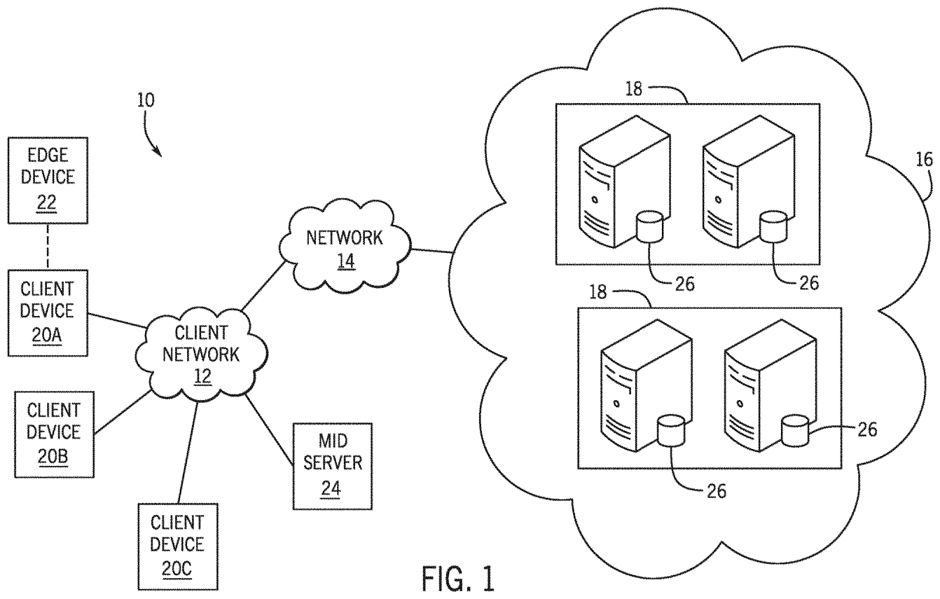

With the preceding in mind, the following figures relate to various types of generalized system architectures or configurations that may be employed to provide services to an organization on which the present approaches may be employed. Correspondingly, these system and platform examples may also relate to systems and platforms on which the techniques discussed herein may be implemented or otherwise utilized. Turning now to FIG. 1, a schematic diagram of an embodiment of a computing system 10, such as a cloud computing system, in which embodiments of the present disclosure may operate, is illustrated. The computing system 10 may include a client network 12, a network 14 (e.g., the Internet), and a cloud-based platform 16. In some implementations, the cloud-based platform 16 may be a configuration management database (CMDB) platform. In one embodiment, the client network 12 may be a local private network, such as a local area network (LAN) that includes a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20A-C may be computing systems and/or other types of computing devices generally referred to as Internet of Things (IoT) devices that access cloud computing services, for example, via a web browser application or via an edge device 22 that may act as a gateway between the client devices 20A-C and the platform 16. FIG. 1 also illustrates that the client network 12 includes a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to the network 14, which may include one or more computing networks, such as other LANs, wide area networks (WAN), the Internet, and/or other remote networks, in order to transfer data between the client devices 20A-C and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), WIFI networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20A-C via the client network 12 and network 14. The network hosting the platform 16 provides additional computing resources to the client devices 20A-C and/or the client network 12. For example, by utilizing the network hosting the platform 16, users of the client devices 20A-C are able to build and execute applications for various enterprise, IT, and/or other organization-related functions. In one embodiment, the network hosting the platform 16 is implemented on the one or more data centers 18, where each data center could correspond to a different geographic location. Each of the data centers 18 includes a plurality of servers 26 (also referred to herein as application nodes, virtual servers, application servers, virtual server instances, application instances, or application server instances), where each server 26 can be implemented on a physical computing system, such as a single electronic computing device (e.g., a single physical hardware server) or across multiple-computing devices (e.g., multiple physical hardware servers). Examples of servers 26 include, but are not limited to, a virtual server, a web server (e.g., a unitary Apache installation), an application server (e.g., unitary Java Virtual Machine), and/or a database server.

To utilize computing resources within the platform 16, network operators may choose to configure the data centers 18 using a variety of computing infrastructures. In one embodiment, one or more of the data centers 18 are configured using a multi-instance cloud architecture to provide every customer with its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules.

Although FIG. 1 illustrates specific embodiments of a cloud computing system 10, the disclosure is not limited to the specific embodiments illustrated in FIG. 1. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server. The use and discussion of FIG. 1 are only examples to facilitate ease of description and explanation and are not intended to limit the disclosure to the specific examples illustrated therein. As may be appreciated, the respective architectures and frameworks discussed with respect to FIG. 1 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

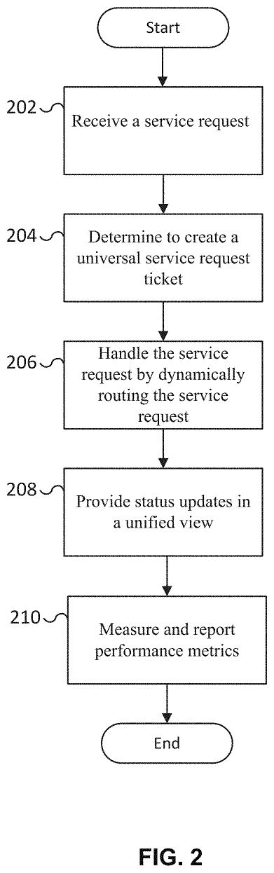

FIG. 2 is a flowchart illustrating an embodiment of a process for managing and handling a universal service request ticket. At least a portion of the process of FIG. 2 may be at least in part implemented on one or more of servers 26 and/or data centers 18 of FIG. 1.

At 202, a service request is received. In various embodiments, the service request is received from an end-user service requestor via an electronic form, a chat (e.g., in a conversation with an automated chatbot), a text message, an email, a voice call, and/or any other electronic communication. The service request indicates a desired service and/or an issue to be resolved. In some embodiments, the service is provided when the end-user has reached a point in a user experience where the user requests help or assistance via a general service inquiry without needing to identify which specific service domain (e.g., department) the request belongs to. The service request may include a description of a desired service or problem/issue to be resolved, an identifier of the requestor, and/or a file attachment of other data that can be used to provide the desired service and/or diagnose the problem/issue to be resolved.

At 204, a universal service request ticket is created for the requested service. For example, the universal ticket is entered into a tracking system (e.g., an incident tracking system) to manage its progress and resolution. The universal ticket tracking system may be hosted on one or more servers 26 and/or data centers 18 of FIG. 1. For example, a system for universal service request ticket processing and management includes a database table for storing information about universal service request tickets and one or more servers for processing universal service request tickets. The universal ticket may include one or more data fields. For example, the universal ticket includes a data field storing a text description of the service request typed/chosen by the end-user or recognized via natural language processing of a language input of the end-user. In another example, the universal ticket includes a data field storing a text description of the end-user's service request understood and inputted by a human or automated agent. A unique identifier (e.g., universal ticket number) is assigned to the universal service request ticket and stored in one of the data fields. Examples of contents of the other fields of the universal ticket include data attachment(s) (e.g., file provided by service requestor), keyword(s), flag(s), a priority indicator associated with the service request, a user account associated with the request, etc. In some embodiments, the universal ticket has been created in response to a determination that the received service request does not indicate or is not directed towards a specific service request domain (e.g., department). For example, the universal ticket is determined to be created for a service request because the service request does not specify a specific service domain (e.g., department) and/or the service request was provided from a form and/or an interaction associated with creating a universal ticket. In some embodiments, any service request causes a universal ticket to be created even if an initial service domain is known, allowing the service request to be transferred to a different service domain easily under the same universal ticket.

The universal ticket may in effect serve as an envelope ticket that allows the service request to be forwarded and routed among different service domains and/or different child tickets dynamically as needed under the same universal ticket that can be cohesively managed. The data structure of the tracking system hosting the universal ticket allows one or more child tickets to be associated with the universal ticket as well as tracking underlying data, messages, results, status, and/or performance metrics for the overall universal ticket as well as any component child tickets.

At 206, the service request under the universal ticket is handled by dynamically routing the service request. In some embodiments, because the service request is ultimately handled by a specific service domain (e.g., either IT department, legal department, human resources department, customer service department, etc.), the service request needs to be routed and sent to a specific service domain that will be handling the service request. However, unlike a preprogrammed workflow that steps through a predetermined sequence of service steps/tickets, the universal ticket allows the routing of the service request to be dynamically determined and performed as often as needed without following a specific predetermined sequence. In some embodiments, the specific service domain destination of the service request is selected by a human reviewer tasked to triage/route service requests and submit to the system the destination service domain for the service request. In some embodiments, the specific service domain destination of the service request is selected automatically. For example, information of the service request and/or universal ticket (e.g., based on a description of the desired service provided by the service requestor end-user) is provided to a machine learning model that automatically predicts and selects the best specific service domain where the service request is to be routed. This machine learning model may have been trained based on correspondences between previous service requests and their descriptions/information and the corresponding specific service domains that successfully resolved the service requests. If the machine learning is unable to select a destination service domain with enough confidence (e.g., prediction score is below a threshold value), the service request may be sent to a human reviewer that will review and select the destination service domain.

In some embodiments, routing the service request includes creating a child service request ticket for the service request in the selected service domain. For example, in order to leverage existing ticket handling capabilities of the different service domains, a new child service request ticket in the ticket handling system of the selected domain is created for the selected domain to process the service request. For example, each different service domain may have its own server, database, data table, and/or data entry for tracking service request tickets in its own domain and the new child service request ticket in this server, database, data table, and/or data entry. These system resources may be at least in part shared with the universal ticket tracking system (e.g., same server/database tracks and processes child tickets and universal tickets) and/or may be at least in part not shared with the universal ticket tracking system (e.g., at least one of the service domains is a part of a third party that tracks and performs its service via an external computer system). Thus the child ticket is assigned its own identifier different from the identifier of the universal ticket for tracking in the system of the selected service domain.

Information required to create the new child ticket (e.g., data fields of the child ticket) may be at least in part automatically migrated and filled out based on information of the universal ticket, information obtained from the service requestor end-user, information from a human or automated agent/bot, and/or other system tracked/stored/known information about the service requestor end-user and/or associated computing devices. The child ticket may be fully or in part created automatically and/or manually by an agent. The child ticket is associated with the universal ticket and an entry in the ticket tracking system for the universal ticket stores and tracks identifiers and status of one or more child tickets created under the universal ticket. The service request is able to be further routed by creating another child ticket for the universal ticket. For example, a processing agent of the child ticket is able to forward/route the service request to another created child ticket (e.g., in the same or different selected service domain). In another example, if the child ticket is returned without fully resolving the service request (e.g., in the same or different selected service domain), another child ticket in another attempt to further resolve the service request is automatically created and/or manually created by a routing agent. In another example, a plurality of child tickets are created for the same universal ticket in parallel in one or more selected service domains to handle the service request in multiple parts.

At 208, status updates are provided in a unified view of the universal request. For example, the tracking system tracks the status, resolution, and other information of the universal ticket and one or more of its child tickets. Current status and/or result of any child ticket of the universal ticket is returned to the universal ticket via a push or pull of data from the tracking/processing system of the child ticket. The service requestor end-user is able to interact with and view the overall status of the universal ticket using a user interface. For example, the status of the child ticket that is being tracked under the universal ticket is provided to the end-user as a status/result of the universal ticket (e.g., obscuring the existence of the child ticket from the end-user), and the end-user is able to send additional questions and/or information via the user interface of the universal ticket that can be passed to an intermediate triage/routing agent and/or passed to an agent of the active child ticket for use in processing the child ticket. Notifications/messages from a child ticket may be masked to make the notification appear as a notification of the universal ticket to the service requestor end-user. For example, the child ticket number of the notification is replaced with the ticket number of the universal ticket. Notifications/messages from a child ticket may be suppressed based on its purpose, type, and/or status of the child ticket. For example, certain types of notifications may not be helpful to the service requestor end-user, and these types of notifications are not indicated to the end-user.

Various agents at different service domains may also view information of the universal ticket (e.g., history of child tickets and its information) but certain information associated with the universal ticket may be hidden from certain agents based on access privileges of the agents. For example, certain sensitive information (e.g., human resources information) from a previous child ticket in one service domain (e.g., human resources department) may not be accessible by an agent in another service domain of another child ticket.

At 210, one or more performance metrics associated with the universal ticket are measured and reported. Because the universal ticket allows the entire service request to be tracked and monitored, a complete and detailed end-to-end analytics can be tracked and reported. For example, the entire ticket resolution time from universal ticket creation time to a final resolution (e.g., via one or more child tickets) that fully resolves the universal ticket can be measured. A routing or triage time of the universal ticket can also be measured. For example, a total amount of time spent without a pending child ticket while the universal ticket was open without final resolution/closure is measured and reported. In some embodiments, an individual resolution time for each child ticket can be individually measured. For example, a time from a child ticket creation to waiting for the child ticket to indicate/return a resolution/end is measured. In some embodiments, an earlier child ticket is not closed until the final child ticket of the universal ticket is closed (e.g., the earlier child ticket may not be closed despite having finished with its processing/service portion until the universal ticket is fully resolved). Thus, the individual resolution time of an earlier child ticket may be paused while waiting on a resolution of another child ticket (e.g., time spent waiting on another child ticket is not counted towards the resolution time of the waiting child ticket). These performance metrics may be analyzed to improve future performance and/or universal ticket handling. For example, detection of unusually long resolution time may invoke an alert for investigation to troubleshoot any issues and improve any detected inefficiencies.

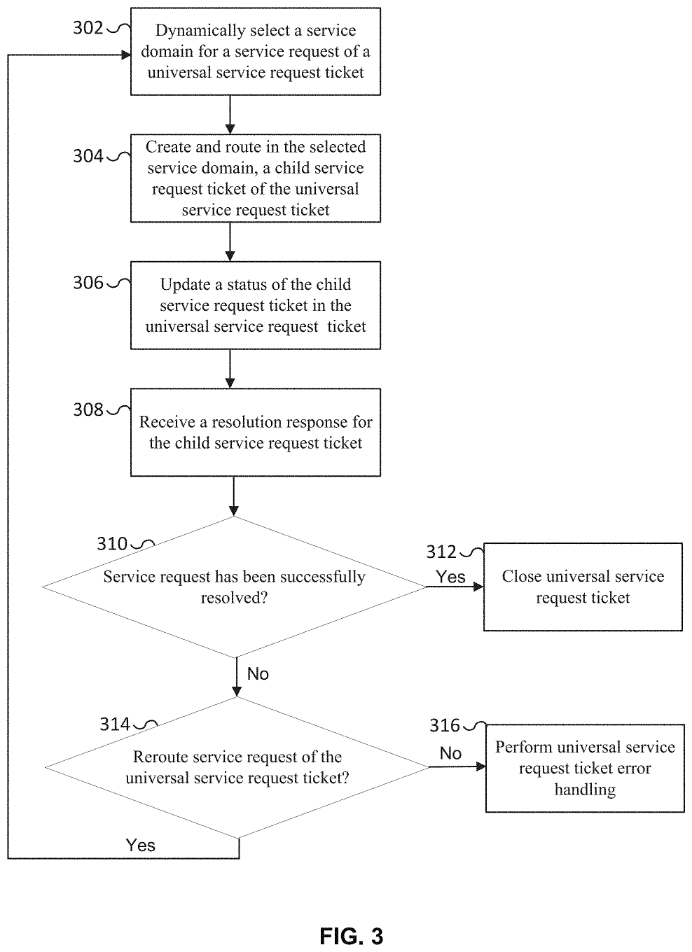

FIG. 3 is a flowchart illustrating an embodiment of a process for processing a universal service request ticket. At least a portion of the process of FIG. 3 may be at least in part implemented on one or more of servers 26 and/or data centers 18 of FIG. 1. In some embodiments, at least a portion of the process of FIG. 3 is performed in 206 of the process of FIG. 2.

At 302, a service domain is dynamically selected for a service request of a universal service request ticket. In some embodiments, because the service request is ultimately handled by a specific service domain (e.g., either IT department, legal department, human resources department, customer service department, etc.), the service request needs to be routed and sent to a specific service domain that will be handling the service request. However, unlike a preprogrammed workflow that steps through a predetermined sequence of service steps/tickets, the universal ticket allows the routing of the service request to be dynamically determined and performed as often as needed without following a specific predetermined sequence. In some embodiments, the specific service domain destination of the service request is selected by a human reviewer tasked to triage/route service requests and submit to the system the destination service domain for the service request. In some embodiments, the specific service domain destination of the service request is selected automatically. For example, information of the service request and/or universal ticket (e.g., based on a description of the desired service provided by the service requestor end-user) is provided to a machine learning model that automatically predicts and selects the best specific service domain where the service request is to be routed. This machine learning model may have been trained based on correspondences between previous service requests and their descriptions/information and the corresponding specific service domains that successfully resolved the service requests. If the machine learning is unable to select a destination service domain with enough confidence (e.g., prediction score is below a threshold value), the service request may be sent to a human reviewer that will review and select the destination service domain.

At 304, a child service request ticket of the universal service request ticket for the service request is created and routed in the selected service domain. For example, in order to leverage existing ticket handling capabilities of the different service domains, a new child service request ticket in the ticket handling system of the selected domain is created for the selected domain to process the service request. For example, each different service domain may have its own server, database, data table, and/or data entry for tracking service request tickets in its own domain and the new child service request ticket in this server, database, data table, and/or data entry. These system resources may be at least in part shared with the universal ticket tracking system (e.g., same server/database tracks and processes child tickets and universal tickets) and/or may be at least in part not shared with the universal ticket tracking system (e.g., at least one of the service domains is a part of a third party that tracks and performs its service via an external computer system). Thus the child ticket is assigned its own identifier different from the identifier of the universal ticket for tracking in the system of the selected service domain.

Information required to create the new child ticket (e.g., data fields of the child ticket) may be at least in part automatically migrated and filled out based on information of the universal ticket, information obtained from the service requestor end-user, information from a human or automated agent/bot, and/or other system tracked/stored/known information about the service requestor end-user and/or associated computing devices. The child ticket may be fully or in part created automatically and/or manually by an agent. The child ticket is associated with the universal ticket and an entry in the ticket tracking system for the universal ticket stores and tracks identifiers and status of one or more child tickets created under the universal ticket.

At 306, status of the child service request ticket is updated in the universal service request ticket. For example, as the child ticket is being processed, the tracking system of the universal ticket tracks the status, resolution, and other information of the child ticket. Current status is returned from a tracking system of the child ticket in the selected service domain to the tracking system of the universal ticket via a pull or push of the status update. The end-user is able to interact with and view the overall status of the universal ticket using a user interface that shows this obtained updated status. For example, the status of the universal ticket is based on the status of its current active child ticket. Notifications/messages from the child ticket may be masked to make the notification appear as a notification of the universal ticket to the service requestor end-user. For example, the child ticket number of the notification is replaced with the ticket number of the universal ticket. Notifications/messages from the child ticket may be suppressed based on its purpose, type, and/or status of the child ticket. For example, certain types of notifications may not be helpful to the service requestor end-user, and these types of notifications are not indicated to the end-user.

At 308, a resolution response for the child service request ticket is received. When the child ticket is finished processing or is no longer able to be processed, the system of the child ticket returns back a response to the system of the universal ticket that indicates a resolution status of the child ticket.

At 310, based on the resolution response, it is determined whether the service request has been successfully resolved. If the requested task of the child ticket was able to be successfully completed, the system of the child ticket provides (e.g., to the system hosting/tracking the universal ticket) the resolution response that indicates the successful completion along with a result, if applicable. If the successful resolution of the child ticket fully resolves the service request of the universal ticket with no other sub tasks or other child tickets remaining, it is determined that the service request has been successfully resolved. If the successful resolution of the child ticket does not fully resolve the service request of the universal ticket or other unresolved sub tasks or other child tickets remain, it is determined that the service request has not been successfully resolved. Additionally if the requested task of the child ticket was unable to be successfully completed, the system of the child ticket that provides the resolution response optionally indicates a new destination where the service request is to be routed/forwarded or otherwise indicates unsuccessful completion and/or an error message, and it is determined that the service request has not been successfully resolved. If there is any pending child ticket that is still being actively processed, the process may wait at 310 for completion before determining whether the service request has been successfully resolved.

If at 310 it is determined that the service request has been successfully resolved, at 312 the universal service request ticket is closed. Closing the universal ticket may include closing any child tickets, updating universal ticket status, and indicating the successful completion to the requestor end-user of the service request. For example, any child ticket created under the universal ticket is not closed until the universal ticket is closed. In some embodiments, a child ticket is closed upon completion of the child ticket regardless of whether the universal ticket is closed. In some embodiments, performance metric collection is completed and analysis of the metrics is performed.

If at 310 it is determined that the service request has not been successfully resolved, at 314 it is determined whether the service request of the universal service request ticket is to be rerouted. For example, the resolution response may indicate that the service request is to be rerouted (e.g., to a different child ticket of a same or different service domain). The service request is able to be further routed by creating another child ticket for the universal ticket. For example, a processing agent of the child ticket is able to forward/route the service request to another created child ticket (e.g., in the same or different selected service domain) as indicated in the resolution response. In another example, if the child ticket is returned without fully resolving the service request (e.g., in the same or different selected service domain), another child ticket in another attempt to further resolve the service request is automatically created and/or manually created by a routing agent.

If at 314 it is determined that the service request is to be rerouted, the process returns to 302 where an appropriate service domain is dynamically selected again for the service request of the universal service request ticket.

If at 314 it is determined that the service request is to be rerouted, at 316 the error handling of the universal service request ticket is performed. For example, the universal ticket may be routed back to an agent where the agent is able to troubleshoot or otherwise attempt to resolve the service request of the universal ticket. This resolution may involve returning back to 302 or 304 where a new appropriate child ticket is created by the agent to handle the service request.

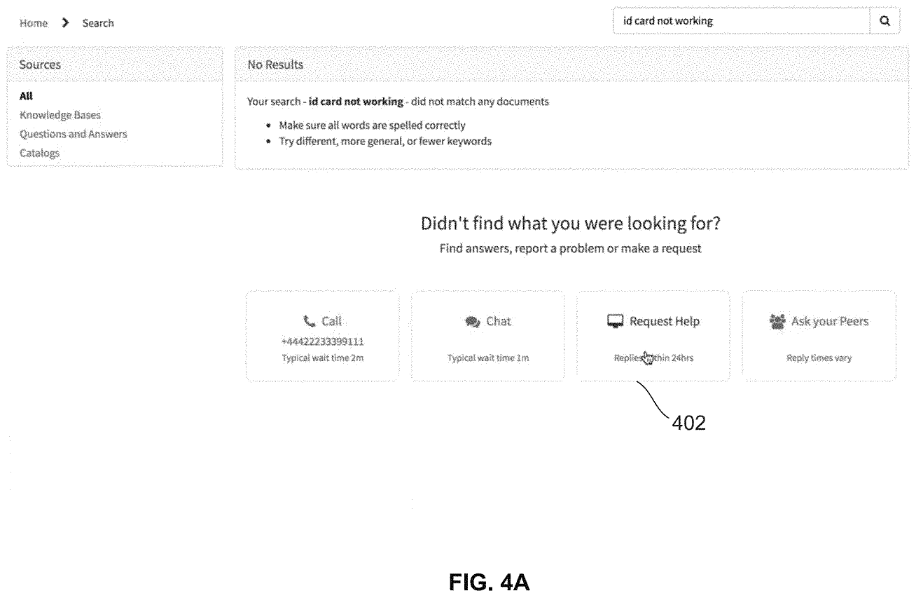

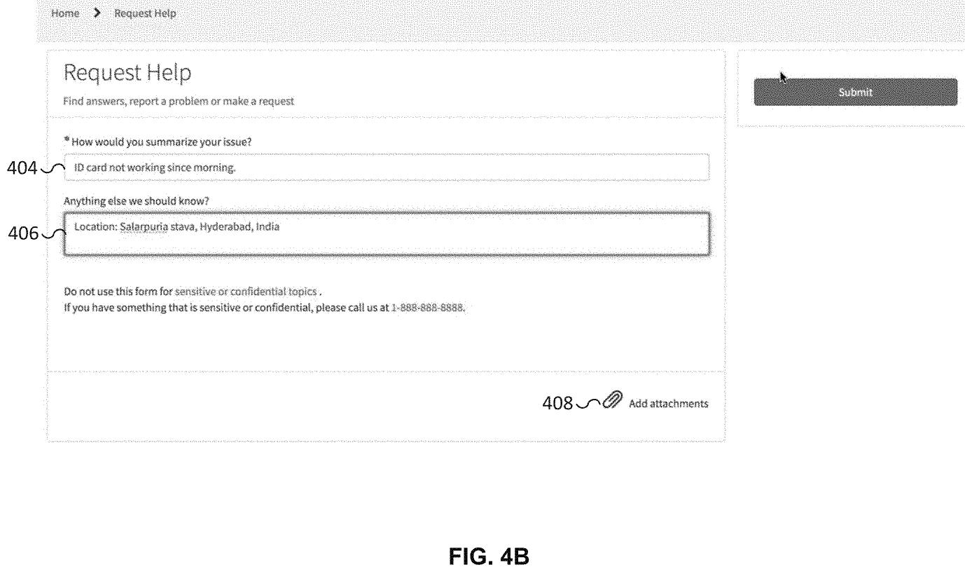

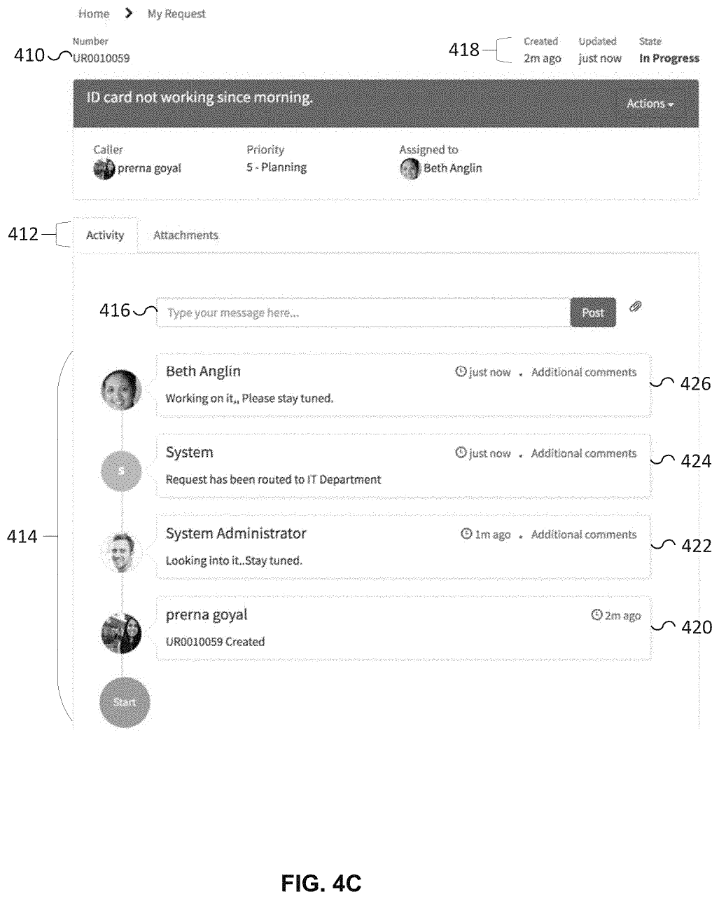

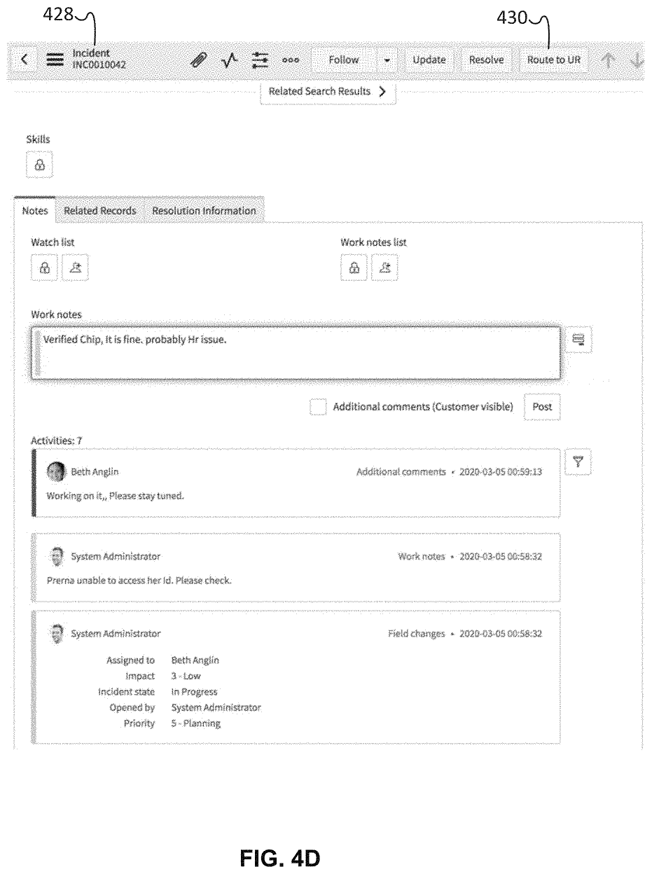

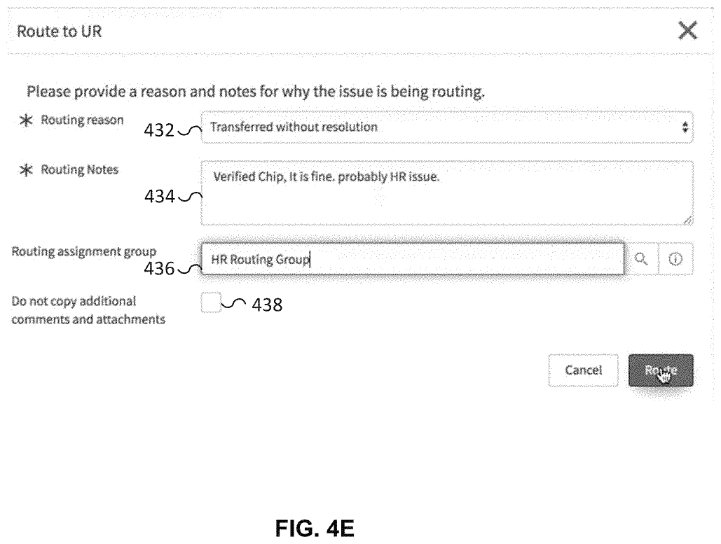

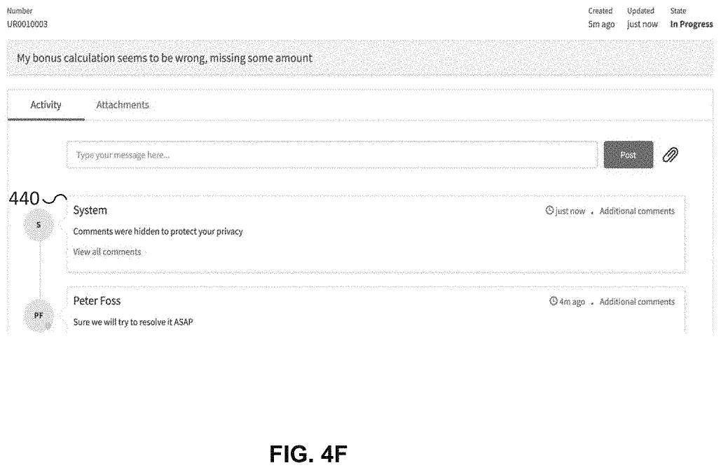

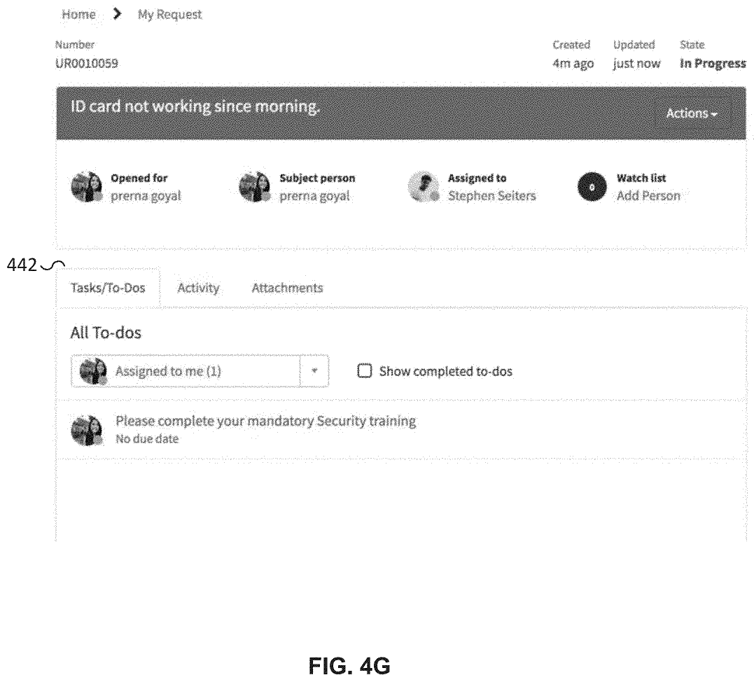

FIGS. 4A-4G show example user interfaces associated with a universal service request ticket. For example, the FIGS. 4A-4G illustrate example user interfaces associated with one or more steps of the processes of FIGS. 2-3.

FIG. 4A shows an example user interface where a universal ticket can be initiated. A user has searched “id card not working” but no document or assistance in a specific domain has been suggested. To initiate a generic request for service, an end-user can select button 402 to initiate a universal ticket. Then the end-user is provided the example user interface shown in FIG. 4B. The user fills out text input box 404 with a summary of the issue the end-user is experiencing and fills out text input box 406 with additional information the end-user desires to provide for this service request to resolve the issue. The end-user is also able to attach any files by selecting icon 408. When the end-user submits the shown form of FIG. 4B, a service request is sent. For example, this request is received in 202 of FIG. 2.

FIG. 4C shows an example user interface utilized by the service requestor end-user to view, manage, and interact with a universal ticket. For example, the interface shown in FIG. 4C is utilized in 208 of FIG. 2 to provide the unified view. Identifier 410 shows the identifier of a universal ticket that has been created for the service request requested using FIG. 4B. Tabs 412 show various different tabs the user can select. The currently selected activity tab shows a history of activities for the universal ticket. The user is able to select the attachments tab to view file attachment associated with the universal ticket. Activity stream 414 shows a chronological history stream of activities and messages for the universal ticket along with an amount of time passed since each activity item. Activity item 420 shows the creation of the universal ticket. Activity item 422 shows a message/comment from a triage/routing agent. Activity item 424 shows that the universal ticket was routed to a specific service domain (e.g., routed to IT department in 304 of FIG. 3). A child ticket for this routing was created when the universal ticket was routed but this is obfuscated from the end-user and appears to the end-user as just a part of the same universal ticket, allowing every step of the universal ticket to be viewed and managed cohesively under the combined interface of the universal ticket. Activity item 424 shows a message from an agent of the child ticket in the specific service domain where the service request was routed. Thus activity stream 414 not only shows the messages from the triage/routing agent, it unifies the presentation of messages from many different agents including any other agent(s) of child ticket(s). The end-user is able to input a message in input box 416. When this message is posted, the message is provided to the agent of the currently active child ticket and/or a triage/routing agent of the universal ticket. The provided message will be retained in activity stream 414 to allow later review of the activity/message history. Status area 418 shows the current elapsed time statistics and status of the universal ticket. It also shows the elapsed time since universal ticket creation, the elapsed time since the last update/activity of the universal ticket, and a current status state. This current status state is based on the state of the currently active child ticket.

FIG. 4D shows an example user interface utilized by an agent of a child service request ticket of the universal ticket. Text 428 shows the service domain specific identifier assigned to the child ticket of the universal ticket. The service domain utilizes this identifier to track and manage the child ticket. If the service request of the child ticket is unable to be successfully resolved or additional processing is required, the agent in the specific service domain is able to request the service request to be routed to a different child ticket and/or service domain by selecting button 430. When button 430 is selected, the agent may be provided the example interface shown in FIG. 4E. The agent inputs the reason for the routing request in box 432 (e.g., select either “Transferred with resolution” or “Transferred without resolution”), routing notes (e.g., work notes for the triage/routing universal ticket agent) in box 434, and destination service domain in box 436. In some embodiments, once the child ticket is routed back to the triage/routing universal ticket agent, this agent can review the resolution, ask the service requestor end-user for confirmation, transfer the service request to the same department by creating a new child ticket for the same department, or transfer the service request to the different department by creating a new child ticket for the different department. Box 438 can be checked if the information provided in the interface of FIG. 4E includes sensitive information (e.g., HR information) to not be shared with other agents. For example, the information provided in the text fields of FIG. 4E is by default shown in activity feed 414 that is accessible not only by the requestor end-user but also other agents of child tickets of the universal ticket that may be in various other service domains. Selecting box 438 hides this sensitive information of the transfer/routing request from being viewed by other agents viewing the status/history information of the universal ticket. FIG. 4F shows an example activity history feed view for a universal ticket and details of activity item 440 that have been hidden because the agent checked box 438 of FIG. 4E.

FIG. 4G shows an example user interface utilized by a service requestor end-user to manage a universal ticket. As compared to the interface of FIG. 4C, the example shown in FIG. 4G includes an additional tab, Task/To-Dos tab 442. This tab shows activities/actions requested to be performed by the end-user. For example, in order to resolve a child ticket, the agent of the child ticket may request the end-user to perform an activity/task. This request indicated for the child ticket is routed back to the universal ticket and shown in the interface of the universal ticket under Task/To-Dos tab 442. The end-user is able to select items listed under this tab to initiate and complete the activity/task. Once complete, an indication is provided to the child ticket where the agent of the child ticket is able to verify its completion and resolve/close the child ticket if appropriate.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving a service request;
creating a universal service request ticket for the service request;
routing the service request to a dynamically selected service domain including by creating for the dynamically selected service domain a child service request ticket of the universal service request ticket; and
updating a status of the universal service request ticket based on a status of the child service request ticket of the dynamically selected service domain.

2. The method of claim 1, wherein the service request does not indicate a specific service domain where the service request belongs.

3. The method of claim 1, wherein the dynamically selected service domain is a specific department selected to handle at least a portion of the service request.

4. The method of claim 1, wherein the dynamically selected service domain was selected at is least in part by a trained machine learning model based on content of the service request.

5. The method of claim 1, wherein the dynamically selected service domain was selected at least in part by a human agent.

6. The method of claim 1, wherein the dynamically selected service domain was selected among a plurality of service domain options.

7. The method of claim 6, wherein the plurality of service domain options includes one or more of the following: an Information Technology (IT) department, a legal department, a human resources department, or a customer service department.

8. The method of claim 1, wherein the service request was received via one or more of the following: an electronic form, a chat with an agent, a chat with a chatbot, a text message, an email, or a voice call.

9. The method of claim 1, wherein the universal service request ticket serves as an envelope ticket that manages a plurality of different child service request tickets.

10. The method of claim 1, wherein the universal service request ticket has a first ticket identifier of a first ticket tracking system different from a second ticket identifier of the child service request ticket of a second ticket tracking system.

11. The method of claim 1, wherein creating the child service request ticket includes automatically transferring information of the universal service request ticket to the child service request ticket.

12. The method of claim 1, further comprising routing the service request to a new dynamically selected service domain via a new child service request ticket in response to a transfer request from a processing agent.

13. The method of claim 1, further comprising tracking and reporting one or more performance metrics associated with the universal service request ticket.

14. The method of claim 13, wherein the one or more performance metrics include one or more of the following: a total elapsed time to resolution of the universal service request ticket, a total amount of routing time, or a total elapsed time to resolution of the child service request is ticket.

15. The method of claim 1, wherein the updated status of the universal service request ticket is provided via a management user interface associated with the universal service request ticket.

16. The method of claim 15, wherein the management user interface provides an activity stream of events associated with the universal service request ticket.

17. The method of claim 16, further comprising receiving child service request ticket associated information identified as to be hidden and hiding the information from display in the activity stream of events.

18. The method of claim 16, wherein the activity stream of events displays communication messages between a requestor of the service request and a plurality of different agents.

19. A system, comprising:
one or more processors configured to:
receive a service request;
create a universal service request ticket for the service request;
route the service request to a dynamically selected service domain including by creating for the dynamically selected service domain a child service request ticket of the universal service request ticket; and
update a status of the universal service request ticket based on a status of the child service request ticket of the dynamically selected service domain; and
a memory coupled to at least one of the one or more processors and configured to provide the at least one of the one or more processors with instructions.

20. A computer program product embodied in a non-transitory computer readable medium and comprising computer instructions for:
to receiving a service request;
creating a universal service request ticket for the service request;
routing the service request to a dynamically selected service domain including by creating for the dynamically selected service domain a child service request ticket of the universal service request ticket; and
is updating a status of the universal service request ticket based on a status of the child service request ticket of the dynamically selected service domain.
